(19) United States
(12) Patent Application Publication
(10) Pub. No.: US 2024/0337052 A1
(43) Pub. Date: Oct. 10, 2024

(54) SUSTAINABLE SOUND-ABSORBING NONWOVEN FABRIC

(71) Applicant: Carl Freudenberg KG, Weinheim (DE)

(72) Inventors: Angela WEIK, Bruehl (DE); Willi MITSCH, Heppenheim (DE); Luka PLETERSKI, Ljubljana (SI)

(21) Appl. No.: 18/625,245

(22) Filed: Apr. 3, 2024

(30) Foreign Application Priority Data
Apr. 4, 2023 (EP) 23 166 484.8

(51) Int. Cl. D04H 1/4382; B09B 3/35; B09B 101/85; D04H 1/70

(52) U.S. Cl. CPC D04H 1/43835; B09B 3/35; D04H 1/70; B09B 2101/85; D10B 2401/021

(57) ABSTRACT

A thermally solidified sound-absorbing nonwoven fabric having a fluid resistance of 150 Ns/m³ to 5000 Ns/m³, measured in accordance with DIN EN 29053, May 1993, and an area density of 150 g/m² to 600 g/m², including structural staple fibers having a mean titer of 0.9 dtex to 8.8 dtex, in a proportion of 50 wt.-% to 90 wt.-% in relation to an overall weight of the nonwoven fabric, and core-spun binding fibers in a proportion of 10 wt.-% to 50 wt.-% in relation to the overall weight of the nonwoven fabric. The structural staple fibers include a percentage of reprocessed structural staple fibers and the core-spun binding fibers include a percentage of reprocessed core-spun binding fibers.

### CROSS REFERENCE TO RELATED APPLICATIONS

This application claims benefit to European Patent Application No. EP 23 166 484.8, filed on Apr. 4, 2023, which is hereby incorporated by reference herein.

### FIELD

The invention relates to a sustainable sound-absorbing nonwoven fabric having a low area density. The invention further relates to a method for its manufacture and its use.

### BACKGROUND

Sound-absorbing nonwoven fabrics are used for the most varied applications. An important field of application is the use as an acoustic absorber in the automotive industry. EP 3 246 442 (A1) describes a sound-absorbing textile composite, comprising
a) at least one open pore carrier layer comprising coarse staple fibers having a mean titer of 3 dtex to 17 dtex and fine staple fibers having a mean titer of 0.3 dtex to 2.9 dtex, in particular of 0.5 dtex to 2.9 detx, as structural fibers, and
b) a micro-porous flow layer arranged on the carrier layer comprising micro fibers having a fiber diameter of less than 10 μm. The fluid resistance of the sound-absorbing textile composite is from 250 Ns/m³ to 5000 Ns/m³, in particular from 250 Ns/m³ to 2000 Ns/m³. The carrier layer can include core-spun fibers as binding fibers.

It is advantageous when the acoustic absorbers combine good acoustic properties with a low area density. Further, it is advantageous when they are at least partially made from sustainable sources.

One approach for the manufacture of sustainable acoustic absorbers is the use of reprocessed fiber materials as raw materials. Such commercially available acoustic absorbers, however, have an outward appearance that is extremely irregular. Moreover, they usually have only very poor sound absorption properties and thus have to be used with a comparatively high area density of usually more than 600 g/m². This is in contrast, however, to the increasing efforts made in view of a desirable lightweight design of automotive vehicles.

A further approach utilizes r-PET fibers which are obtained from recycled PET bottles. In this approach, the desired sound absorption may be achievable with light materials. However, the PET bottle resource will become ever scarcer, which is why further alternatives of sustainable fiber resources are needed for the manufacture of efficient acoustic absorbers.

### SUMMARY

In an embodiment, the present disclosure provides a thermally solidified sound-absorbing nonwoven fabric having a fluid resistance of 150 Ns/m3 to 5000 Ns/m3, measured in accordance with DIN EN 29053, May 1993, and an area density of 150 g/m2 to 600 g/m2, comprising structural staple fibers having a mean titer of 0.9 dtex to 8.8 dtex, in a proportion of 50 wt.-% to 90 wt.-% in relation to an overall weight of the nonwoven fabric, and core-spun binding fibers in a proportion of 10 wt.-% to 50 wt.-% in relation to the overall weight of the nonwoven fabric. The structural staple fibers include a percentage of reprocessed structural staple fibers and the core-spun binding fibers include a percentage of reprocessed core-spun binding fibers.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a photograph of primary structural fibers;

FIG. 2 is a photograph of reprocessed structural fibers;

FIG. 3 is an REM image of a melted primary binding fiber;

FIG. 4 is an REM image of a reprocessed binding fiber (not re-melted);

FIG. 5 is an REM image of a re-melted reprocessed binding fiber;

FIG. 6 shows a nonwoven fabric according to an embodiment of the invention with fiber nests;

FIG. 7 shows a nonwoven fabric, which includes only primary fibers and no fiber nests; and

FIG. 8 shows the sound absorption of nonwoven fabrics according to an embodiment of the invention in the alpha cabin.

### DETAILED DESCRIPTION

In an embodiment, the invention provides a sustainable acoustic absorber which does not have to rely on r-PET fibers obtained from recycled PET bottles as a source of raw materials and which has good acoustic and mechanical properties. A method for the manufacture of an acoustic absorber and its use is also provided.

A thermally solidified sound-absorbing nonwoven fabric is provided having a fluid resistance of 150 Ns/m³ to 5000 Ns/m³, preferably of 150 Ns/m³ to 3000 Ns/m³, more preferably of 150 Ns/m³ to 2000 Ns/m³, in particular, of 150 Ns/m³ to 1000 Ns/m³, measured in accordance with DIN EN 29053, May 1993, and an area density of 150 g/m² to 600 g/m², comprising:
a) structural staple fibers having a mean titer of 0.9 dtex to 8.8 dtex, preferably 0.9 dtex to 6.7 dtex, in particular 0.9 dtex to 3.3 dtex, in a proportion of 50 wt.-% to 90 wt.-%, preferably 60 wt.-% to 80 wt.-%, more preferably 70 wt.-% to 80 wt.-%, in relation to the overall weight of the nonwoven fabric, and
b) core-spun binding fibers in a proportion of 10 wt.-% to 50 wt.-%, preferably of 20 wt.-% to 40 wt.-%, more preferably 20 wt.-% to 30 wt.-%, in relation to the overall weight of the nonwoven fabric,
wherein the structural staple fibers include a percentage of reprocessed structural staple fibers and the core-spun binding fibers include a percentage of reprocessed core-spun binding fibers.

It has been found that the nonwoven fabric according to an embodiment of the invention, despite its proportion of reprocessed fibers, has very good acoustic and mechanical properties. Reprocessed fibers are fibers which have been obtained in a mechanical method for disintegrating the structure of textile waste (shredding process). The observed good acoustic and mechanical properties were surprising since the fibers are mechanically extremely strained and thus also partially destroyed by the shredding process. Moreover, reprocessed fibers in nonwoven fabrics of the state of the art have a wide spectrum of fiber lengths with a proportion of short fibers and a proportion of non-disintegrated fibers and sheet portions. This leads to a combination of properties substantially differing from the primary fibers. As a consequence, it was to be expected that the acoustic properties would suffer, in particular. It was therefore particularly surprising that in the manufacture of the nonwoven fabric the cover of the core-spun binding fibers also melts sufficiently a second time and thus enables binding.

As explained above, reprocessed fibers are fibers which have been obtained from textile waste by means of a shredding process. The shredding process is a mechanical process for the disintegration of the structure of textile waste. The objective of the process is the recuperation of the fibers contained in the textile waste and their reuse as a raw material in a new product cycle.

The shredding process is described, for example, in Hilmar Fuchs, Wilhelm Albrecht: “Vliesstoffe: Rohstoffe, Herstellung, Anwendung, Eigenschaften, Prüfung” (“Nonwoven fabrics: raw materials, manufacture, application, properties, testing”) (Jul. 18, 2012), second edition, Wiley VCH.

On the other hand, in an embodiment of the present invention, primary fiber are fibers which have not been recycled by means of a shredding process. Reprocessed fibers can be distinguished from primary fibers in that they have a damaged fiber structure which is visually identifiable. For example, this can be recognized in the reprocessed structural fibers as an irregular or completely destroyed crimp structure and/or inhomogeneous fiber length. Reprocessed binding fibers further have, at least before they have been melted again, an at least partially destroyed binding component, which can be seen as an irregular fiber contour. When reprocessed core-spun binding fibers are thermally solidified as in the nonwoven fabric according to an embodiment of the invention, they can be distinguished from thermally solidified primary core-spun binding fibers for example in that they have a more irregular structure, in which, for example, two cores are enclosed by a common cover or the cover is present in a deformed, for example, lumpy, state.

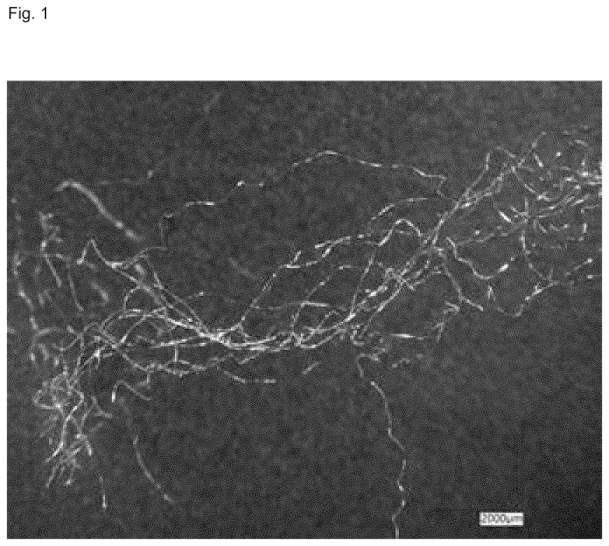

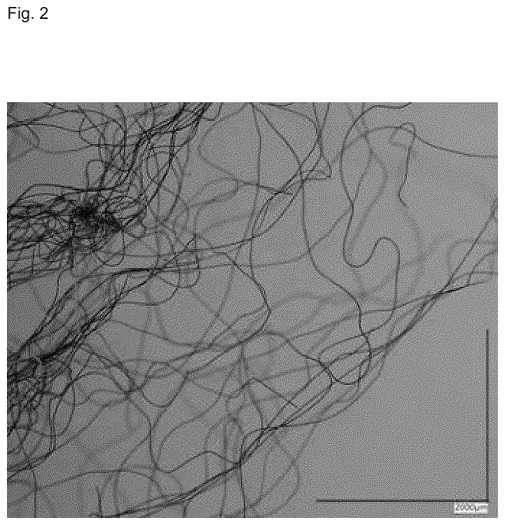

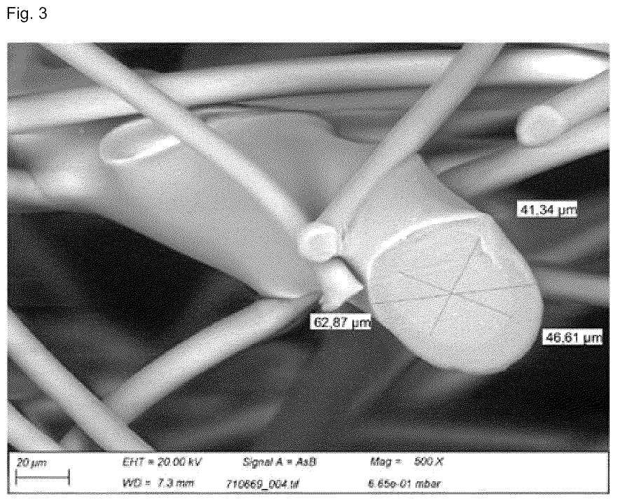

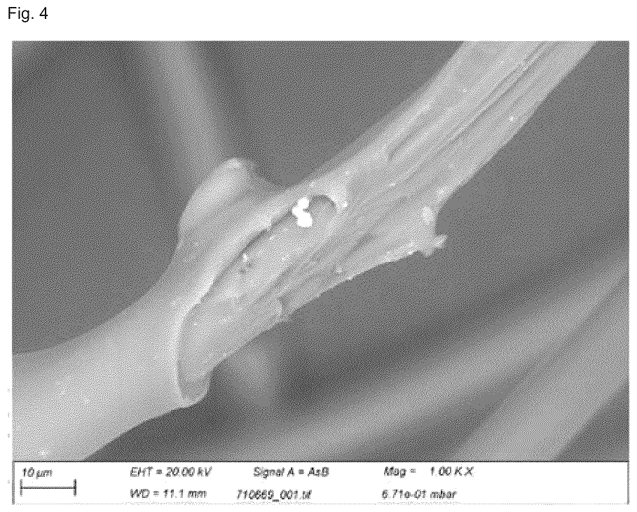

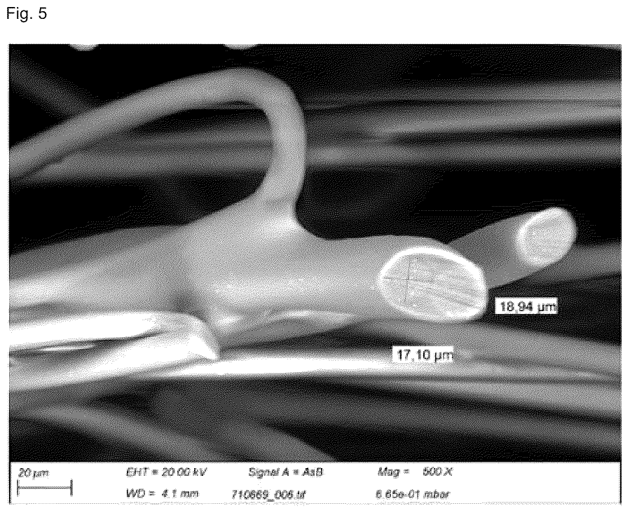

FIG. 1 shows a photograph of primary structural fibers. The strongly crimped and homogeneous crimping of the fibers is shown. FIG. 2 shows a photograph of reprocessed structural fibers. Substantially weaker and irregular crimping of the fibers is to be seen. FIG. 3 shows an REM image of a melted primary binding fiber. A comparatively regular fiber contour is to be seen. Irregularities are only caused by the melting together of the binding component and by a structural fiber being broken out at one point. The breaking out is due to the specimen preparation in which a portion of the nonwoven fabric is cut out and in the present case the fiber was levered out. FIG. 4 shows an REM image of a reprocessed binding fiber (not melted together again). The partially destroyed binding component is clearly visible. FIG. 5 shows an REM image of a reprocessed binding fiber melted together again. It can be seen how two cores are enclosed by a common cover.

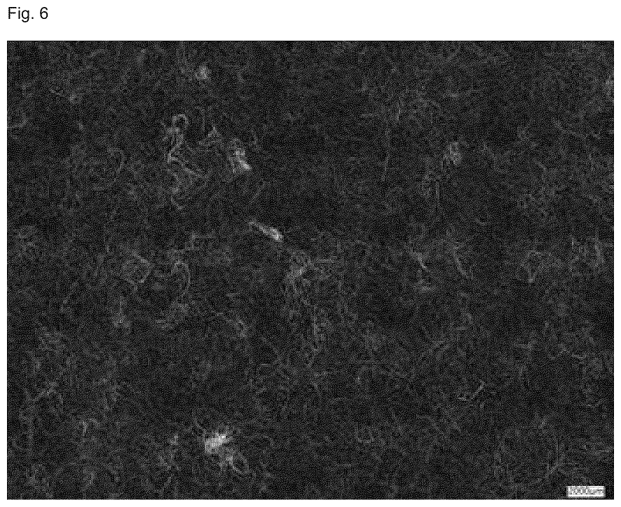

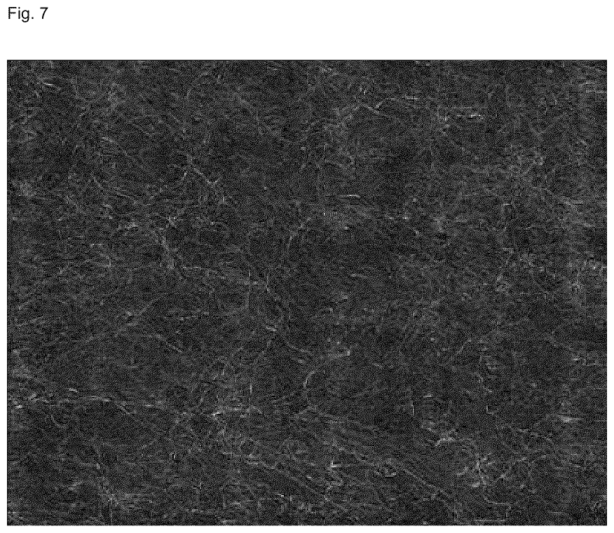

Furthermore, microscopic photographs of examples of the nonwoven fabric according to embodiments of the invention have shown that it has a less regular fiber distribution than nonwoven fabrics of the same structure which only contain primary fibers. It has thus been found that the reprocessed core-spun binding fibers form “fiber nests”, in which a larger percentage of binding fibers is present than in the rest of the nonwoven fabric. FIG. 6 shows a nonwoven fabric according to an embodiment of the invention with fiber nests in white color. As a comparative example, FIG. 7 shows a nonwoven fabric which only contains primary fibers and no fiber nests.

A nonwoven fabric is a structure of fibers of limited length, endless fibers (filaments) or cut yarns of any type and any origin which have been combined to form a web (a fiber layer, a fiber web) in any way and joined together in any way; excluded is the crossing or intertwining of yarns, as in weaving, knitting, knit-meshing, lace-making, plaiting, and the production of tufted products. Films and papers are not part of the nonwoven fabrics. Nonwoven fabrics are described in DIN EN ISO 9092, August 2019.

According to an embodiment of the invention, the nonwoven fabric has structural staple fibers having a mean titer of 0.9 dtex to 8.8 dtex, preferably 0.9 dtex to 6.7 dtex, in particular 0.9 dtex to 3.3 dtex, in a proportion of 50 wt.-% to 90 wt.-%, preferably 60 wt.-% to 80 wt.-%, more preferably 70 wt.-% to 80 wt.-%, in relation to the overall weight of the nonwoven fabric, wherein the structural staple fibers include a percentage of reprocessed structural staple fibers.

Structural staple fibers are staple fibers having fiber components which, in contrast to the binding components of binding fibers, are not melted together. This is the usual meaning of structural fibers. Preferably, core-spun binding fibers are also staple fibers. Staple fibers are, as is the rule in this field of engineering, fibers having defined lengths as distinguished from theoretically endless filaments.

According to an embodiment of the invention, the structural staple fibers include a proportion of reprocessed structural staple fibers. Herein, the reprocessed structural staple fibers have a mean titer of 0.9 dtex to 8.8 dtex, preferably 0.9 dtex to 6.7 dtex, in particular 0.9 dtex to 3.3 dtex. In a preferred embodiment of the invention, the reprocessed structural staple fibers have a mean staple length of 5 mm to 60 mm, more preferably of 10 mm to 55 mm, in particular of 10 mm to 50 mm.

In a preferred embodiment of the invention, the reprocessed structural staple fibers contain at least one melt-spinnable polymer. Polymers are preferably selected from polyacrylonitrile, polyvinyl alcohols, viscose-, polyamide, in particular, polyamide 6 and polyamide 6.6, polyolefin and/or polyester. Polyolefin and/or polyester are preferred. Polyester is particularly preferred.

Particularly preferably, the reprocessed structural staple fibers contain at least one polyester selected from the group consisting of polyethylene terephthalate, polypropylene terephthalate, poly(tetramethylene terephthalate), poly(decamethylene terephthalate), poly-1,4-cyclohexylene dimethyl terephthalate, polybutylene terephthalate, polyethylene naphthalate, polyglycolic acid, polylactides, polycaprolactones, polyethylene adipates, polyhydroxyalkanoates, polyhydroxybutyrates, poly-3-hydroxybutyrate-co-3-hydroxyvalerates, polytrimethylene terephthalates, vectran, polyethylene naphthalate, copolymers and/or mixtures thereof. Particularly preferred polyesters are polyethylene terephthalate, polyethylene naphthalate and polybutylene terephthalate, mixtures and/or copolymers thereof. Particularly preferably, the reprocessed structural staple fibers include polyethylene terephthalate. The reprocessed structural staple fibers contain the afore-mentioned polymers and, in particular, the polyethylene terephthalate in a percentage of 50 wt.-% to 100 wt.-%, more preferably 70 wt.-% to 100 wt.-%, more preferably 80 wt.-% to 100 wt.-%, in relation to the overall weight of the reprocessed structural staple fibers and, in particular, they consist of the polymers mentioned here.

In addition to the reprocessed structural staple fibers, the nonwoven fabric, in a preferred embodiment, contains primary structural staple fibers, wherein the primary structural staple fibers preferably have a mean titer of 0.9 dtex to 8.8 dtex, more preferably 0.9 dtex to 6.7 dtex, in particular 0.9 dtex to 3.3 dtex. If present, the primary structural staple fibers preferably have a mean staple length of 20 mm to 80 mm, more preferably from 25 mm to 80 mm, in particular from 30 mm to 80 mm.

In a preferred embodiment of the invention, the primary structural staple fibers include at least one melt-spinnable polymer. Preferably, polymers are selected from polyacrylonitrile, polyvinyl alcohols, viscose-, polyamide, in particular polyamide 6 and polyamide 6.6, polyolefin and/or polyester. Polyolefin and/or polyester are preferred. Polyester is particularly preferred.

Particularly preferably, the primary structural staple fibers contain at least one polyester selected from the group consisting of polyethylene terephthalate, polypropylene terephthalate, poly(tetramethylene terephthalate), poly(decamethylene terephthalate), poly-1,4-cyclohexylene dimethyl terephthalate, polybutylene terephthalate, polyethylene naphthalate, polyglycolic acid, polylactides, polycaprolactones, polyethylene adipates, polyhydroxyalkanoates, polyhydroxybutyrates, poly-3-hydroxy butyrate-co-3-hydroxy valerates, polytrimethylene terephthalates, vectran, polyethylene naphthalate, copolymers and/or mixtures thereof. Particularly preferred polyesters include polyethylene terephthalate, polyethylene naphthalate and polybutylene terephthalate, mixtures and/or copolymers thereof. Particularly preferably, the primary structural staple fibers contain polyethylene terephthalate. The primary structural staple fibers contain the aforementioned polymers and, in particular, the polyethylene terephthalate, preferably in a percentage of 50 wt.-% to 100 wt.-%, more preferably of 70 wt.-% to 100 wt.-%, even more preferably of 80 wt.-% to 100 wt.-%, in relation to the overall weight of the primary structural staple fibers and, in particular, they consist of the polymers mentioned here.

According to an embodiment of the invention, the nonwoven fabric includes core-spun binding fibers in a proportion of 10 wt.-% to 50 wt.-%, preferably of 20 wt.-% to 40 wt.-%, more preferably 20 wt.-% to 30 wt.-%, in relation to the overall weight of the nonwoven fabric, wherein the core-spun binding fibers include a proportion of reprocessed core-spun binding fibers.

Binding fibers are fibers which have at least one binding component which is present in the form of a more or less deformed fiber structure or even a completely melted continuous phase. The binding component can help to achieve an adhesive bond of the web material. In core-spun binding fibers, the cover functions as the binding component.

Also preferably, the reprocessed core-spun binding fibers have a mean titer in the range from 1.7 dtex to 6.7 dtex, preferably from 1.7 dtex to 5 dtex.

Preferably, the reprocessed core-spun binding fibers include, in their cores, a polymer (core polymer) different from the cover polymer. After re-solidification, the core polymer can be present in a state where it is partially or completely surrounded by the binding component. The amount ratio between the core and the cover polymer can be freely chosen. Ratios of 90:10 to 10:90 (weight ratio core:cover in wt.-%), more preferably of 80:20 to 20:80, even more preferably of 80:20 to 30:70 and, in particular, from 80:20 to 40:60 have proven particularly advantageous.

According to a preferred embodiment, the cover polymer of the reprocessed core-spun binding fibers has a melting point that is lower than that of the core polymer of the reprocessed core-spun binding fibers. The difference in the melting temperatures of the cover polymer and the core polymer is preferably at least 5° C., preferably at least 8° C., particularly preferably at least 10° C. This difference in the melting temperatures of the two polymers leads to good temperature stability.

The core polymer of the reprocessed core-spun binding fibers can include the most varied materials. Preferably, the core polymer is a melt-spinnable polymer. Preferably, polymers are selected from polyacrylonitrile, polyvinyl alcohol, viscose-, polyamide, in particular polyamide 6 and polyamide 6.6, polyolefin and/or polyester. Polyolefin and/or polyester are preferred. Polyester is particularly preferred.

Particularly preferably, the core polymer includes at least one polyester selected from the group consisting of polyethylene terephthalate, polypropylene terephthalate, poly(tetramethylene terephthalate), poly(decamethylene terephthalate), poly-1,4-cyclohexylene dimethyl terephthalate, polybutylene terephthalate, polyethylene naphthalate, polyglycolic acid, polylactides, polycaprolactones, polyethylene adipates, polyhydroxyalkanoates, polyhydroxybutyrates, poly-3-hydroxy butyrate-co-3-hydroxy valerates, polytrimethylene terephthalates, vectran, polyethylene naphthalate, copolymers and/or mixtures thereof. Particularly preferred polyesters are polyethylene terephthalate, polyethylene naphthalate and polybutylene terephthalate, mixtures and/or co-polymers thereof. Particularly preferably, the core polymer includes polyethylene terephthalate. The core polymer includes the aforementioned polymers and, in particular, the polyethylene terephthalate, preferably in a percentage of 50 wt.-% to 100 wt.-%, more preferably of 70 wt.-% to 100 wt.-%, even more preferably of 80 wt.-% to 100 wt.-%, in relation to the overall weight of the core polymer and, in particular, it consists of the polymers mentioned here.

Insofar as the nonwoven fabric contains primary core-spun binding fibers, the core polymer of the reprocessed core-spun binding fibers is preferably the same polymer and/or the same polymers as the core polymers of the primary core-spun binding fibers.

The cover polymer of the reprocessed core-spun binding fibers can also contain the most varied materials. Preferably, the cover polymer includes co-polyesters, in particular co-polyethylene terephthalate. Statistical copolymers, gradient copolymers, alternating copolymers, block copolymers and graft copolymers are suitable, for example, as copolymers. The copolymers can consist of two, three, four or more different monomers (terpolymers, tetrapolymers). Particularly preferred further co-monomers are monomers of the following polymers: aromatic and aliphatic polyesters, aromatic and aliphatic polyamides, aromatic and aliphatic epoxides, aromatic and aliphatic polyurethanes, polysiloxanes, polyacrylates, polyacrylamides.

The cover polymer of the reprocessed core-spun binding fibers contains the co-polyethylene terephthalate preferably in a percentage of 50 wt.-% to 100 wt.-%, more preferably of 70 wt.-% to 100 wt.-%, even more preferably of 80 wt.-% to 100 wt.-%, in relation to the overall weight of the cover polymer of the reprocessed core-spun binding fibers.

Insofar as the nonwoven fabric contains primary core-spun binding fibers, the cover polymer of the reprocessed core-spun binding fibers preferably contains the same polymer and/or the same polymers as the cover polymer of the primary core-spun binding fibers.

Preferably, the cover polymer of the reprocessed core-spun binding fibers has a melting point in the range below 250° C., more preferably from 70 to 235° C., even more preferably from 125 to 225° C., particularly preferably from 150 to 225° C.

Insofar as the nonwoven fabric contains primary structural fibers and/or primary core-spun binding fibers, the reprocessed core-spun binding fibers preferably have the same mean titer and/or the same polymers as the primary core-spun binding fibers and/or the reprocessed structural fibers have the same mean titer and/or the same polymers as the primary structural fibers.

In a preferred embodiment, the nonwoven fabric contains primary core-spun binding fibers. The primary core-spun binding fibers are preferably staple fibers, preferably having a mean staple length of 20 mm to 80 mm, more preferably from 25 mm to 80 mm, in particular, from 30 mm to 80 mm.

Also preferably, the primary core-spun binding fibers have a mean titer in the range from 1.7 dtex to 6.7 dtex, preferably from 1.7 detx to 5 dtex.

According to an embodiment of the invention, the primary core-spun binding fibers preferably include, in the core, a polymer (core polymer) different from the cover polymer. The amount ratio between the core and the cover polymer can be freely chosen. Ratios of 90:10 to 10:90 (weight ratio core:cover in wt.-%), more preferably of 80:20 to 20:80, even more preferably of 80:20 to 30:70 and, in particular, from 80:20 to 40:60 have proven particularly advantageous.

According to a preferred embodiment, the cover polymer of the primary core-spun binding fibers has a melting point that is lower than that of the core polymer of the primary core-spun binding fibers. The difference in the melting temperatures of the cover polymer and the core polymer is preferably at least 5° C., preferably at least 8° C., particularly preferably at least 10° C. This difference in the melting temperatures of the two polymers leads to good temperature stability.

The core polymer of the primary core-spun binding fibers can include the most varied materials. Preferably, the core polymer is a melt-spinnable polymer. Polymers are preferably selected from polyacrylonitrile, polyvinyl alcohols, viscose-, polyamide, in particular, polyamide 6 and polyamide 6.6, polyolefin and/or polyester. Polyolefin and/or polyester are preferred. Polyester is particularly preferred.

Particularly preferably, the core polymer includes at least one polyester selected from the group consisting of polyethylene terephthalate, polypropylene terephthalate, poly(tetramethylene terephthalate), poly(decamethylene terephthalate), poly-1,4-cyclohexylene dimethyl terephthalate, polybutylene terephthalate, polyethylene naphthalate, polyglycolic acid, polylactides, polycaprolactones, polyethylene adipates, polyhydroxyalkanoates, polyhydroxybutyrates, poly-3-hydroxy butyrate-co-3-hydroxy valerates, polytrimethylene terephthalates, vectran, polyethylene naphthalate, copolymers and/or mixtures thereof. Particularly preferred polyesters are polyethylene terephthalate, polyethylene naphthalate and polybutylene terephthalate, mixtures and/or co-polymers thereof. Particularly preferably, the core polymer includes polyethylene terephthalate. The core polymer includes the aforementioned polymers and, in particular, the polyethylene terephthalate, preferably in a percentage of 50 wt.-% to 100 wt.-%, more preferably of 70 wt.-% to 100 wt.-%, even more preferably of 80 wt.-% to 100 wt.-%, in relation to the overall weight of the core polymer and, in particular, it consists of the polymers mentioned here.

The cover polymer of the primary core-spun binding fibers can also include the most varied materials. Preferably, the cover polymer includes co-polyesters, in particular co-polyethylene terephthalate. Statistical copolymers, gradient copolymers, alternating copolymers, block copolymers and graft copolymers are suitable, for example, as copolymers. The copolymers can consist of two, three, four or more different monomers (terpolymers, tetrapolymers). Particularly preferred further co-monomers are monomers of the following polymers: aromatic and aliphatic polyesters, aromatic and aliphatic polyamides, aromatic and aliphatic epoxides, aromatic and aliphatic polyurethanes, polysiloxanes, polyacrylates, polyacrylamides.

The cover polymer of the primary core-spun binding fibers contains the co-polyethylene terephthalate preferably in a percentage of 50 wt.-% to 100 wt.-%, more preferably of 70 wt.-% to 100 wt.-%, even more preferably of 80 wt.-% to 100 wt.-%, in relation to the overall weight of the cover polymer of the primary core-spun binding fibers.

Preferably, the cover polymer of the primary core-spun binding fibers has a melting point in the range below 250° C., more preferably from 70 to 235° C., even more preferably from 125 to 225° C., particularly preferably from 150 to 225° C.

In a preferred embodiment of the invention, the nonwoven fabric includes reprocessed fibers in an amount of 8 wt.-% to 100 wt.-%, more preferably in an amount of 10 wt.-% to 80 wt.-%, even more preferably in an amount of 15 wt.-% to 70 wt.-%, in particular in an amount of 20 wt.-% to 60 wt.-%, each in relation to the overall weight of the sound-absorbing nonwoven fabric. A high percentage of reprocessed fibers is advantageous in view of sustainability.

In an embodiment of the invention, the nonwoven fabric includes primary fibers in an amount of less than 15 wt.-%, preferably of less than 10 wt.-%, in particular, of less than 5 wt.-%, each in relation to the overall weight of the sound-absorbing nonwoven fabric. In an embodiment of the invention, the nonwoven fabric does not include primary fibers.

In an embodiment of the invention, the nonwoven fabric contains structural staple fibers having a mean titer of 0.9 dtex to 8.8 dtex, preferably 0.9 dtex to 6.7 dtex, in particular 0.9 dtex to 3.3 dtex, in a proportion of 60 wt.-% to 90 wt.-%, preferably 70 wt.-% to 80 wt.-%, in relation to the overall weight of the nonwoven fabric.

In an embodiment of the invention, the nonwoven fabric includes core-spun binding fibers in a proportion of 20 wt.-% to 40 wt.-%, more preferably 20 wt.-% to 30 wt.-%, in relation to the overall weight of the nonwoven fabric.

In a preferred embodiment of the invention, the nonwoven fabric contains primary fibers in an amount of 5 wt.-% to 92 wt.-%, more preferably in an amount of 20 wt.-% to 90 wt.-%, more preferably in an amount of 30 wt.-% to 85 wt.-%, in particular, 40 wt.-% to 80 wt.-%, each in relation to the overall weight of the sound-absorbing nonwoven fabric.

Further preferably, the proportion of reprocessed structural staple fibers in relation to the overall weight of the structural staple fibers is 10 to 100 wt.-%, preferably 15 wt.-% to 80 wt.-%, even more preferably 20 wt.-% to 70 wt.-%, in particular, 20 wt.-% to 60 wt.-%.

Also preferably, the proportion of reprocessed core-spun binding fibers in relation to the overall weight of the core-spun binding fibers is 10 to 100 wt.-%, preferably 20 wt.-% to 75 wt.-%, even more preferably 30 wt.-% to 80 wt.-%, in particular, 40 wt.-% to 80 wt.-%.

In a preferred embodiment, the nonwoven fabric includes 5 wt.-% to 90 wt.-%, more preferably from 10 wt.-% to 80 wt.-%, more preferably from 15 wt.-% to 70 wt.-%, more preferably from 20 wt.-% to 60 wt.-%, in particular from 20 wt.-% to 50 wt.-%, reprocessed structural staple fibers in relation to the overall weight of the sound-absorbing nonwoven fabric.

In a preferred embodiment, the nonwoven fabric includes 1 wt.-% to 50 wt.-%, more preferably from 5 wt.-% to 40 wt.-%, more preferably from 7.5 wt.-% to 30 wt.-%, in particular from 10 wt.-% to 20 wt.-%, reprocessed core-spun binding fibers in relation to the overall weight of the sound-absorbing nonwoven fabric.

In a preferred embodiment, the nonwoven fabric includes, each in relation to the overall weight of the nonwoven fabric:
a) 0 wt.-% to 70 wt.-%, preferably 10 wt.-% to 65 wt.-%, more preferably 20 wt.-% to 55 wt.-%, in particular, 30 wt.-% to 45 wt.-% primary structural staple fibers;
b) 0 wt.-% to 70 wt.-%, preferably 5 wt.-% to 60 wt.-%, more preferably 10 wt.-% to 50 wt.-%, in particular, 15 wt.-% to 40 wt.-%, primary core-spun binding fibers;
c) 5 wt.-% to 90 wt.-%, more preferably 10 wt.-% to 80 wt.-%, more preferably 15 wt.-% to 70 wt.-%, more preferably 20 wt.-% to 60 wt.-%, in particular 20 wt.-% to 50 wt.-%, reprocessed structural staple fibers;
d) 1 wt.-% to 50 wt.-%, more preferably 5 wt.-% to 40 wt.-%, more preferably 7.5 wt.-% to 30 wt.-%, in particular 10 wt.-% to 20 wt.-% reprocessed core-spun binding fibers.

The nonwoven fabric according to an embodiment of the invention has a fluid resistance of 150 Ns/m³ to 5000 Ns/m³, preferably of 150 Ns/m³ to 3000 Ns/m³, more preferably of 150 Ns/m³ to 2000 Ns/m³, in particular, of 150 Ns/m³ to 1000 Ns/m³, measured in accordance with DIN EN 29053, May 1993.

The nonwoven fabric according to an embodiment of the invention further preferably includes a sound absorption grade, measured in the alpha cabin (DIN EN ISO 354:2003) at a thickness of 10 to 50 mm, more preferably from 10 to 35 mm, in particular, at a thickness of 10 mm, as well as measured at 1000 Hz, of more than 0.35, preferably more than 0.4.

Furthermore, the nonwoven fabric according to an embodiment of the invention has an area density of 150 g/m² to 600 g/m², preferably of 200 g/m² to 550 g/m², more preferably of 250 g/m² to 500 g/m².

Preferably, the nonwoven fabric according to an embodiment of the invention has a thickness, measured in accordance with DIN EN ISO 9073-2 (1997-02), methods B and C, of 10 to 50 mm, more preferably of 10 to 35 mm.

Furthermore, the nonwoven fabric according to an embodiment of the invention has a maximum tensile strength in the longitudinal direction (in accordance with DIN EN ISO 9073-2, 2022-05) of 25 N to 100 N, more preferably of 30 N to 100 N, in particular of 40 N to 100 N and/or a maximum tensile force in the transverse direction (in accordance with DIN EN ISO 9073-2, 2022-05) of 25 N to 100 N, more preferably of 30 N to 100 N, in particular of 40 N to 100 N.

Further preferably, the nonwoven fabric according to an embodiment of the invention has an internal nonwoven strength, measured following DIN 54310 1980 of more than 0.5 N/5 cm, for example of 0.5 N/5 cm to 10 N/5 cm, and/or of 0.5 N/5 cm to 3 N/5 cm and/or of 0.5 N/5 cm to 2.5 N/5 cm.

In a preferred embodiment, the sound-absorbing nonwoven fabric is made of textile waste which was reprocessed in a shredding method in such a manner that the reprocessed textile waste consists of individual textile fibers in a percentage of at least 70 wt.-%, preferably of 70 wt. % to 100 wt.-%, more preferably 80 wt.-% to 100 wt.-%, more preferably 90 wt.-% to 100 wt.-%, in relation to the overall weight of reprocessed textile waste. To determine their amount, the individual textile fibers are manually separated from specimens of the reprocessed textile waste (10 g). At least 10 specimens are extracted and the result is averaged.

Further preferably, the sound-absorbing nonwoven material is made of textile waste which was reprocessed in a shredding method in such a manner that the reprocessed textile waste contains non-disintegrated textile residues, such as neps and sheet portions in an amount of less than 30 wt.-%, preferably of 0 wt.-% to 30 wt.-%, preferably of 0 to 20 wt.-%, more preferably of 0 to 10 wt.-%, in relation to the overall amount of reprocessed textile waste. To determine their amount, the non-disintegrated textile residues are manually separated from specimens of the reprocessed textile waste (10 g). At least 10 specimens are extracted and the result is averaged.

Further preferably, the sound-absorbing nonwoven fabric is made of textile waste, which contains nonwoven fabric and was reprocessed in a shredding method, particularly preferably of textile waste, which contains nonwoven fabric in a proportion of more than 90 wt.-%, for example, 90 wt.-% to 100 wt.-%, more preferably 95 wt.-% to 100 wt.-%. Particularly preferably, the sound-absorbing nonwoven material is made from textile waste reprocessed in a shredding method, which comprises only one type of material.

In a preferred embodiment, the sound-absorbing nonwoven fabric is manufactured of reprocessed textile waste, comprising:
a) structural staple fibers having a mean titer of 0.9 dtex to 8.8 dtex, preferably from 0.9 dtex to 6.7 dtex, in particular from 0.9 dtex to 3.3 dtex in a proportion of 50 wt.-% to 90 wt.-%, preferably from 60 wt.-% to 80 wt.-%, more preferably from 70 wt.-% to 80 wt.-%, in relation to the overall weight of the reprocessed textile waste, and
b) core-spun binding fibers in a proportion of 10 wt.-% to 50 wt.-%, preferably from 20 wt.-% to 40 wt.-%, more preferably from 20 wt.-% to 30 wt.-%, in relation to the overall weight of the reprocessed textile waste.

In an embodiment of the invention, a method is provided for the production of a sound-absorbing nonwoven fabric having a fluid resistance of 150 Ns/m³ to 5000 Ns/m³, preferably of 150 Ns/m³ to 3000 Ns/m³, more preferably of 150 Ns/m³ to 2000 Ns/m³, in particular, of 150 Ns/m³ to 1000 Ns/m³, measured in accordance with DIN EN 29053, May 1993, and an area density of 150 g/m² to 600 g/m², comprising the steps of:
I. providing textile waste, including
a) structural staple fibers having a mean titer of 0.9 dtex to 8.8 dtex, preferably 0.9 dtex to 6.7 dtex, in particular 0.9 dtex to 3.3 dtex, in a proportion of 50 wt.-% to 90 wt.-%, preferably 60 wt.-% to 80 wt.-%, more preferably 70 wt.-% to 80 wt.-%, in relation to the overall weight of the textile waste, and
b) core-spun binding fibers in a proportion of 10 wt.-% to 50 wt.-%, preferably from 20 wt.-% to 40 wt.-%, more preferably from 20 wt.-% to 30 wt.-%, in relation to the overall weight of the textile waste;
II. at least partially disintegrating the textile structure of the textile waste in a shredding process, whereby reprocessed textile waste is obtained having a proportion of reprocessed structural staple fibers and a proportion of reprocessed core-spun binding fibers;
III. forming a web from the reprocessed textile waste;
IV. heat treating the web, thus obtaining the sound-absorbing nonwoven fabric.

Method steps I) to IV) are preferably carried out in succession.

Preferably, a thermally solidified sound-absorbing nonwoven fabric is produced in the method according to an embodiment of the invention, comprising:
a) structural staple fibers having a mean titer of 0.9 dtex to 8.8 dtex, preferably 0.9 dtex to 6.7 dtex, in particular 0.9 dtex to 3.3 dtex, in a proportion of 50 wt.-% to 90 wt.-%, preferably 60 wt.-% to 80 wt.-%, more preferably 70 wt.-% to 80 wt.-%, in relation to the overall weight of the nonwoven fabric, and
b) core-spun binding fibers in a proportion of 10 wt.-% to 50 wt.-%, preferably from 20 wt.-% to 40 wt.-%, more preferably from 20 wt.-% to 30 wt.-%, in relation to the overall weight of the nonwoven fabric,
wherein the structural staple fibers include a percentage of reprocessed structural staple fibers and the core-spun binding fibers include a percentage of reprocessed core-spun binding fibers and wherein the sound-absorbing nonwoven fabric has an area density of 150 g/m² to 600 g/m².

A thermally solidified sound-absorbing nonwoven fabric according to any one or more of the embodiments described here is further preferably produced with the method according to an embodiment of the invention.
Step I. of the method according to an embodiment of the invention comprises providing textile waste, which includes structural staple fibers having a mean titer of 0.9 dtex to 8.8 dtex, preferably 0.9 dtex to 6.7 dtex, in particular 0.9 dtex to 3.3 dtex, in a proportion of 50 wt.-% to 90 wt.-%, preferably 60 wt.-% to 80 wt.-%, more preferably 70 wt.-% to 80 wt.-%, in relation to the overall weight of the textile waste; and core-spun binding fibers in a proportion of 10 wt.-% to 50 wt.-%, preferably from 20 wt.-% to 40 wt.-%, more preferably from 20 wt.-% to 30 wt.-%, in relation to the overall weight of the reprocessed textile waste. Various textile wastes are suitable for the method according to an embodiment of the invention. Preferably, the textile waste includes fibers according to any one or more embodiments, as described for the sound-absorbing nonwoven fabric according to embodiments of the invention.

The textile waste can originate from various sources such as clothing and technical textiles. Preferably, the textile waste includes nonwoven fabric. Particularly preferably, the textile waste includes nonwoven fabric in a proportion of more than 90 wt.-%, for example from 90 wt.-% to 100 wt.-%, more preferably from 95 wt.-% to 100 wt.-%, in relation to the overall weight of the textile waste. The textile waste can also include fabrics and/or knitted fabrics. The textile waste further preferably comprises one type of material. Furthermore, the textile waste can be present as old textiles, as filament or thread rests or even as marginal strips from web production. Mixtures of different forms are also possible.

Step I. can also be followed by optional step I.1, in which the textile waste is pre-shredded, preferably by means of cutting.

Furthermore, step I. or step I.1 can be followed by optional step I.2, in which the pre-shredded, as the case can be, textile waste is moistened and/or lubricated. This is advantageous for the subsequent structural disintegration. Furthermore, fiber friction can be reduced and thus the energy expenditure can be reduced and fiber damage can be reduced.

Step II. of the method comprises the at least partial disintegration of the textile structure of the textile waste in a shredding process, thus obtaining reprocessed textile waste.

In a preferred embodiment, the shredding process is performed in a shredding machine, the operating principle thereof consisting in the textile waste being fed through an intake system operative in a transporting and simultaneously clamping manner to a shredding unit, preferably a rotating drum on which shredding members are arranged. The rotating drum is preferably a shredding tambour. The shredding members are preferably pin-like, hook-like or tooth-like. Preferably, the shredding members are configured as a sawtooth assembly. The shredding members engage the textile waste clamped by the intake system and tear apart its structure at least in part by subjecting it to tensile stresses.

The textile waste can be subjected to the shredding process one or more times. It is also possible that only part of the textile waste is subject to the shredding process several times. Preferably, the shredding process comprises at least two shredding passes. For this purpose, after one shredding pass in the shredding unit, the textile waste can be fed to the same shredding unit again. It is also possible, however, to arrange a plurality of shredding units in series. The material carryover between the shredding units can be carried out, for example, by means of screen drums. In a preferred embodiment of the invention, the number and grade of the shredding members arranged on the various shredding units is adapted to the progressing structural disintegration of the textile waste.

The intake system can comprise a roll pair or the combination of a rotating roll and a fixed trough. Preferably, the intake system is configured as a trough intake. Herein, the material clamping point is situated at the trough's edge. This is advantageous, since it can thus be brought closer to the region of action of the shredding members.

By adjusting various parameters of the shredding process, in particular by the number of the shredding units through which the textile waste passes, a desirable structural disintegration of the textile waste can be adjusted.

Preferably, the textile structure of the textile waste is disintegrated to such an extent that the reprocessed textile waste has at most a percentage of 30 wt.-%, more preferably from 0 to 30 wt.-%, more preferably from 0 to 20 wt.-%, more preferably from 0 to 10 wt.-%, non-disintegrated textile residues, such as neps and sheet portions. Preferably, the textile structure of the textile waste is disintegrated to such an extent that the reprocessed textile waste includes at least 70 wt.-%, preferably from 70 wt.-% to 100 wt.-%, more preferably 80 wt.-% to 100 wt.-%, more preferably 90 wt.-% to 100 wt.-% individual textile fibers in relation to the overall weight of the reprocessed textile waste. The reprocessed textile waste obtained in step II. thus preferably includes at least 70 wt.-%, preferably from 70 wt.-% to 100 wt.-%, more preferably 80 wt.-% to 100 wt.-%, more preferably 90 wt.-% to 100 wt.-%, individual textile fibers. Further preferably, reprocessed textile waste obtained in step II. includes non-disintegrated textile residues, such as neps and sheet portions in a proportion of less than 30 wt.-%, more preferably from 0 to 30 wt.-%, more preferably from 0 to 20 wt.-%, more preferably from 0 to 10 wt.-%, in relation to the overall amount of reprocessed textile waste. To determine the proportion of non-disintegrated textile waste, the non-disintegrated textile residues are manually separated from specimens of the reprocessed textile waste (10 g). At least 10 specimens are extracted and the result is averaged.

The textile waste obtained in step II. can be post-processed to improve quality. For example, fine cleaning can be carried out to reduce the content of short fibers and/or to separate rough and foreign matter. Furthermore, the desired fiber finishing features, such as flame resistant, fungicidal and/or antistatic finishing can be applied.

In a preferred embodiment of the invention, the reprocessed textile waste obtained in step II. includes:
a) structural staple fibers having a mean titer of 0.9 dtex to 8.8 dtex, preferably 0.9 dtex to 6.7 dtex, in particular 0.9 dtex to 3.3 dtex, in a proportion of 50 wt.-% to 90 wt.-%, preferably 60 wt.-% to 80 wt.-%, more preferably 70 wt.-% to 80 wt.-%, in relation to the overall weight of the reprocessed textile waste; and
b) core-spun binding fibers in a proportion of 10 wt.-% to 50 wt.-%, preferably from 20 wt.-% to 40 wt.-%, more preferably from 20 wt.-% to 30 wt.-%, in relation to the overall weight of the reprocessed textile waste.

In a preferred embodiment of the invention, the reprocessed textile waste obtained in step II. includes, each in relation to the overall weight of the reprocessed textile waste:
a) 5 wt.-% to 90 wt.-%, more preferably from 10 wt.-% to 80 wt.-%, more preferably from 15 wt.-% to 70 wt.-%, more preferably from 20 wt.-% to 60 wt.-%, in particular from 20 wt.-% to 50 wt.-%, reprocessed structural staple fibers having a mean titer of 0.9 dtex to 8.8 dtex, preferably 0.9 dtex to 6.7 dtex, in particular 0.9 dtex to 3.3 dtex;
b) 1 wt.-% to 50 wt.-%, more preferably 5 wt.-% to 40 wt.-%, more preferably 7.5 wt.-% to 30 wt.-%, in particular 10 wt.-% to 20 wt.-% reprocessed core-spun binding fibers.

Step II. can be followed by optional step II.1, comprising mixing the reprocessed textile waste obtained in step II. with primary structural staple fibers and/or primary core-spun binding fibers, wherein a reprocessed textile waste containing primary fibers is obtained. Preferably, a reprocessed textile waste is obtained in step II.1, which includes, in relation to the overall weight of the reprocessed textile waste:
a) 0 wt.-% to 70 wt.-%, preferably 10 wt.-% to 65 wt.-%, more preferably 20 wt.-% to 55 wt.-%, in particular 30 wt.-% to 45 wt.-%. primary structural staple fibers;
b) 0 wt.-% to 70 wt.-%, preferably 5 wt.-% to 60 wt.-%, more preferably 10 wt.-% to 50 wt.-%, in particular 15 wt.-% to 40 wt.-%, primary core-spun binding fibers;
c) 5 wt.-% to 90 wt.-%, more preferably 10 wt.-% to 80 wt.-%, more preferably 15 wt.-% to 70 wt.-%, more preferably 20 wt.-% to 60 wt.-%, in particular 20 wt.-% to 50 wt.-%, reprocessed structural staple fibers;
d) 1 wt.-% to 50 wt.-%, more preferably 5 wt.-% to 40 wt.-%, more preferably 7.5 wt.-% to 30 wt.-%, in particular 10 wt.-% to 20 wt.-%, reprocessed core-spun binding fibers.

In step III. of the method according to an embodiment of the invention, a web is formed of the reprocessed textile waste obtained in step II. or II.1. The web formation can be carried out in various ways known to the person skilled in the art, for example, by means of carding.

In step IV. of the method according to an embodiment of the invention, the web obtained in step III. is heat treated, wherein a sound-absorbing nonwoven fabric is obtained having a fluid resistance of 150 Ns/m³ to 5000 Ns/m³, preferably of 150 Ns/m³ to 3000 Ns/m³, more preferably of 150 Ns/m³ to 2000 Ns/m³, in particular, of 150 Ns/m³ to 1000 Ns/m³, measured in accordance with DIN EN 29053, May 1993, and an area density of 150 g/m² to 600 g/m². The area density can be adjusted, as known to the person skilled in the art, by suitably adjusting the area density during laying of the web. Preferably, the heat treatment is carried out at temperatures from 110° C. to 220° C., preferably from 120° C. to 200° C. Further preferably, the heat treatment is carried out in a through-air oven.

In an embodiment of the invention, a sound-absorbing nonwoven fabric is provided, which is produced by the method according to embodiments of the invention.

In an embodiment of the invention, a use of the sound-absorbing nonwoven fabric according to embodiments of the invention for sound absorption in the automotive industry, in particular in the interior of an automotive vehicle, is provided.

To determine parameters used according to embodiments of the invention, the following measuring methods are used:

### Testing Method for Measuring Sound Absorption in Echo Chambers (Alpha Cabin)

In accordance with DIN EN ISO 354:2003, the measurement is carried out in an alpha cabin. The specimens are directly placed on the floor and measured with frames.

### Determination of the Proportion of the Reprocessed Structural Staple Fibers and the Reprocessed Core-Spun Binding Fibers in Reprocessed Textile Waste

At least 10 specimens (5 g) are taken from the reprocessed textile waste. The fibers are manually separated with pincers. Core-spun binding fibers having an at least partially destroyed binding component are counted as reprocessed core-spun binding fibers. Structural staple fibers having an irregular, or even a completely destroyed, crimp structure are counted as reprocessed structural staple fibers.

### Determination of the Proportion of the Reprocessed Structural Staple Fibers and the Reprocessed Core-Spun Binding Fibers in the Nonwoven Fabric

At least 5 specimens are cut out from the nonwoven fabric. At the cutting edges, 10 areas (1 cm²) are inspected under the microscope (resolution as shown in FIG. 3). Core-spun binding fibers having an irregular structure, whereby, for example, two cores are surrounded by a common cover or where the cover is deformed, e.g., in lumps, are counted as reprocessed core-spun binding fibers. Structural staple fibers having an irregular structure, or even a completely destroyed crimp structure, are counted as reprocessed structural staple fibers.

### Testing Methods for Nonwoven Fabrics for Determining the Area Density

In accordance with ISO 9073-1 (1989-07) wherein the surface of the measured specimen is 100 mm×100 mm.

### Testing Methods for Nonwoven Fabrics for Determining the Thickness

In accordance with DIN EN ISO 9073-2 (1997-02), methods B and C.

### Determination of the Fiber Titer

In accordance with DIN 53810 (1981-02) (fineness of spun fibers—terms and measuring principles) with the aid of a microscope and corresponding software to determine the fiber diameter. Four microscopic preparations are to be prepared from an overall number of more than 20 individual fibers. Per microscopic preparation, fibers are shortened to a length of about 2 to 3 mm with the aid of scissors and placed on an object carrier with the aid of a preparation needle. Subsequently, the fiber diameter is determined in μm with the aid of the corresponding software and averaged. The averaged fiber diameter can then be computed to the fiber titer Tt with the aid of the following formula:

$$Tt [ dtex ] = \frac{π * {d}^{2} * ρ}{400}$$

d fiber diameter in μm
ρ density of the fiber in g/cm³

### Determination of the Staple Length

10 fiber bundles are selected from a fiber specimen at hand, wherein an individual fiber is extracted from each of the 10 fiber bundles with the aid of pincers and the fiber length of the 10 individual fibers is determined by clamping a free fiber end in one of the 2 clamps and the second fiber end is clamped in the remaining clamp. By turning the hand wheel, the fiber is stretched until it is crimp-free. The length of the fiber is read from the scale on the measuring device and is to be noted in millimeters. The average value of all results obtained indicates the staple length:

$$SP [ mm ] = \frac{\sum L}{n}$$

ΣL sum of individual fiber lengths
n number of fibers in specimen

### Determination of Melting Point

In accordance with DIN EN ISO 11357-3 (2018-07), dynamic difference thermal analysis (DSC)—part 3: determination of the melting and crystallization temperature and the melting and crystallization enthalpy, wherein a heating rate of 10 K/min is used.

Maximum Tensile Force Transverse/Longitudinal (in Accordance with DIN EN ISO 9073-3, 2022-05)

The maximum tensile force is determined as follows:

A tensile testing machine in accordance with DIN 51220 (2003) and DIN EN ISO 7500 (2018) and a stamping iron 260×50 mm is used.

### Specimen Preparation:

The measuring specimens are stamped at a distance of 10 cm from the edge in each of the longitudinal and transverse directions from the specimen at hand.

### Execution:

The measuring specimen is clamped in a uniform, central and plumb manner, then the test is carried out in accordance with the machine-specific instructions and the specimens are pulled apart with the predetermined take-down velocity=200 mm/min and with a biasing force of 0.5 N.

### Internal Nonwoven Strength Following DIN 54310 (1980)

In contrast to the standard, the nonwoven fabric is cut apart parallel to the surface in such a manner that the resulting leg can be clamped in the clamps of a tensile testing machine.

### Testing Method for the Determination of the Fluid Resistance

In accordance with DIN EN 29053 (1993-05), method A (co-current air-flow method), wherein the effective specimen diameter is 100 mm and the air pressure corresponds to 1000 mbar.

Embodiments of the invention will be explained in more detail with reference to the following non-limiting examples.

### Example 1

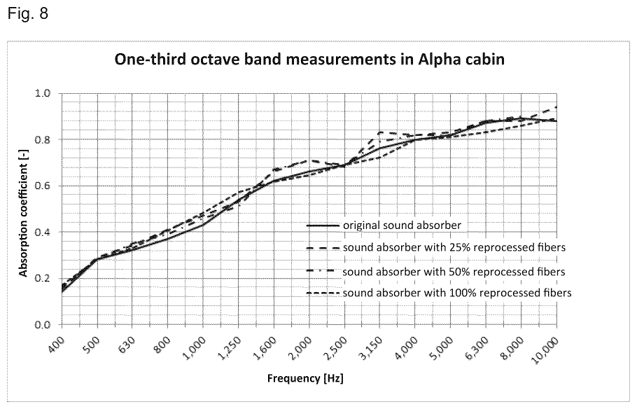

As textile waste, an acoustic absorber consisting of 80 wt.-% 1.7 dtex PET fibers (structural staple fibers, 38 mm) and 20 wt.-% 4.4 dtex PET/CoPET (core-spun binding fibers) are used. The textile waste is moistened and disintegrated in a shredding method in a shredding machine having a sawtooth assembly as a shredding member, and reprocessed textile waste is obtained. This includes non-disintegrated textile residues in a proportion of less than 15 wt.-%. From the reprocessed textile waste, a web is formed by means of a card and a new acoustic absorber with 250 g/m² and 10 mm thickness is produced by heat treatment. The acoustic absorber obtained has a fluid resistance of 153 Ns/m³ and a sound absorption grade, measured in the alpha cabin (DIN EN ISO 354:2003) as shown in FIG. 8. Furthermore, the acoustic absorber has a regular outward appearance and has good mechanical properties. It has a maximum tensile strength in the transverse direction (in accordance with DIA EN ISO 9073-2, 2022-05) of 62 N and an internal nonwoven strength, measured following DIN 54310 1980 of 1.28 N/5 cm.

### Example 2

The reprocessed textile waste obtained in example 1 is mixed with primary structural staple fibers and primary core-spun binding fibers, wherein a reprocessed textile waste containing primary fibers is obtained, which has the same composition with respect to the proportion of structural and binding fibers as the original textile waste from example 1 (80 wt.-% 1.7 dtex PET fibers (38 mm) and 20 wt.-% 4.4 dtex PET/CoPET fibers). The reprocessed textile waste contains a) 25 wt.-% and b) 50 wt.-% reopened fibers.

Webs are formed from the reprocessed textile waste by means of a card and new acoustic absorbers with 250 g/m² and a 10 mm thickness are produced by means of heat treatment. The acoustic absorber obtained with 25 wt.-% and with 50 wt.-% reopened fibers each has a fluid resistance of 160 Ns/m³ and a sound absorption grade as shown in FIG. 8. All of the acoustic absorbers have a regular outward appearance and have good mechanical properties.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A thermally solidified sound-absorbing nonwoven fabric having a fluid resistance of 150 Ns/m³ to 5000 Ns/m³, measured in accordance with DIN EN 29053, May 1993, and an area density of 150 g/m² to 600 g/m², comprising:
a) structural staple fibers having a mean titer of 0.9 dtex to 8.8 dtex, in a proportion of 50 wt.-% to 90 wt.-% in relation to an overall weight of the nonwoven fabric, and
b) core-spun binding fibers in a proportion of 10 wt.-% to 50 wt.-% in relation to the overall weight of the nonwoven fabric,
wherein the structural staple fibers include a percentage of reprocessed structural staple fibers and the core-spun binding fibers include a percentage of reprocessed core-spun binding fibers.

2. The thermally solidified sound-absorbing nonwoven fabric according to claim 1, wherein the nonwoven fabric contains primary structural staple fibers, and
wherein the primary structural staple fibers have a mean titer of 0.9 dtex to 8.8 dtex and/or a mean staple length of 20 mm to 80 mm.

3. The thermally solidified sound-absorbing nonwoven fabric according to claim 1, wherein the nonwoven fabric includes primary core-spun binding fibers, and
wherein the primary core-spun binding fibers are staple fibers, preferably having a staple length of 20 mm to 80 mm.

4. The thermally solidified sound-absorbing nonwoven fabric according to claim 1, wherein the nonwoven fabric includes primary structural staple fibers and/or primary core-spun binding fibers, and
wherein the reprocessed core-spun binding fibers preferably have the same mean titer and/or the same polymers as the primary core-spun binding fibers and/or the reprocessed structural staple fibers have the same mean titer and/or the same polymers as the primary structural staple fibers.

5. The thermally solidified sound-absorbing nonwoven fabric according to claim 1, wherein a proportion of reprocessed structural staple fibers in relation to the overall weight of structural staple fibers is 10 to 100 wt.-% and/or the proportion of reprocessed core-spun binding fibers in relation to the overall weight of the core-spun binding fibers is 10 to 100 wt.-%.

6. The thermally solidified sound-absorbing nonwoven fabric according to claim 1, wherein the nonwoven fabric, includes, each in relation to the overall weight of the nonwoven fabric:
a) 0 wt.-% to 70 wt.-%, preferably 10 wt.-% to 65 wt.-%, primary structural staple fibers;
b) 0 wt.-% to 70 wt.-%, preferably 5 wt.-% to 60 wt.-%, primary core-spun binding fibers;
c) 5 wt.-% to 90 wt.-% reprocessed structural staple fibers; and
d) 1 wt.-% to 50 wt.-%, more preferably 5 wt.-% to 40 wt.-%, reprocessed core-spun binding fibers.

7. The thermally solidified sound-absorbing nonwoven fabric according to claim 1, wherein the nonwoven fabric is made of textile waste reprocessed in a shredding method in such a manner that the reprocessed textile waste includes non-disintegrated textile residues, in particular neps and sheet portions, in a proportion of less than 30 wt.-% in relation to an overall amount of the reprocessed textile waste.

8. A method of manufacturing a sound-absorbing nonwoven fabric having a fluid resistance of 150 Ns/m³ to 5000 Ns/m³, and an area density of 150 g/m² to 600 g/m², the method comprising:
I. providing textile waste, including
a) structural staple fibers having a mean titer of 0.9 dtex to 8.8 dtex, in a proportion of 50 wt.-% to 90 wt.-% in relation to an overall weight of the nonwoven fabric, and
b) core-spun binding fibers in a proportion of 10 wt.-% to 50 wt.-% in relation to the overall weight of a textile waste;
II. at least partially disintegrating the textile structure of the textile waste in a shredding process, whereby reprocessed textile waste is obtained having a proportion of reprocessed structural staple fibers and a proportion of reprocessed core-spun binding fibers;
III. forming a web from the reprocessed textile waste; and
IV. heat treating the web, thus obtaining the sound-absorbing nonwoven fabric.

9. The method according to claim 8, further comprising a step I.2 in which the textile waste is moistened.

10. The method according to claim 8, wherein the shredding process is carried out in a shredding machine such that the textile waste is fed through an intake system operative in a transporting and simultaneously clamping manner to a shredding unit, and
wherein the shredding members are configured as a sawtooth assembly.

11. The method according to claim 8, wherein the textile waste is subjected to a shredding process more than one time.

12. The method according to claim 8, wherein a textile structure of the textile waste is disintegrated in step II to such an extent that the reprocessed textile waste has at most a percentage of 30 wt.-% non-disintegrated textile residues, such as neps and sheet portions, and/or the reprocessed textile waste has at least 70 wt.-% individual textile fibers in relation to the overall weight of the reprocessed textile waste.

13. The method according to claim 8, further comprising mixing the reprocessed textile waste obtained in step II with primary structural staple fibers and/or primary core-spun binding fibers.

14. The method according to claim 8, wherein the nonwoven fabric comprises:
a) structural staple fibers having a mean titer of 0.9 dtex to 8.8 dtex, in a proportion of 50 wt.-% to 90 wt.-% in relation to the overall weight of the nonwoven fabric, and
b) core-spun binding fibers in a proportion of 10 wt.-% to 50 wt.-% in relation to the overall weight of the nonwoven fabric, and
wherein the structural staple fibers include a percentage of reprocessed structural staple fibers and the core-spun binding fibers include a percentage of reprocessed core-spun binding fibers.

15. The method according to claim 8, further comprising arranging the sound-absorbing nonwoven fabric in an automobile.

16. The method according to claim 10, wherein the shredding machine is a rotating drum on which shredding members are arranged.
